(19) United States
(12) Patent Application Publication
(10) Pub. No.: US 2018/0148553 A1
(43) Pub. Date: May 31, 2018

(54) IMPACT RESISTANT FLEXIBLE ACRYLIC SHEETS FOR VEHICLES

(71) Applicant: DONNA MARIE CARTER, NEW ROCHELLE, NY (US)

(72) Inventor: DONNA MARIE CARTER, NEW ROCHELLE, NY (US)

(21) Appl. No.: 15/362,224

(22) Filed: Nov. 28, 2016

(51) Int. Cl. C08J 5/18; C08F 220/14

(52) U.S. Cl. CPC C08J 5/18; C08J 2333/12; C08F 220/14

(57) ABSTRACT

An impact resistant flexible clear sheet for vehicles windshields. There is a material made of a cast polymerization of monomer mixtures comprising at least 50% by weight, based on a weight of a matrix syrup, of methylmethacrylate; wherein the monomer mixture comprise other (meth)acrylates or (alkyl) (meth)acrylates copolymerizable with methylmethacrylate; and wherein the monomer mixture comprise 0 to 10% by weight, based on a weight of a cast solution respectively syrup, of unsaturated carboxylic acids.

### FIELD OF THE INVENTION

The invention relates to flexible plastic glass or flexible acrylic sheets that is used in windows of cars and other utility vehicles. These rolling glass-sheets comprises of polymethacrylate with high molecular weight having impact-resistance.

### BACKGROUND OF THE INVENTION

Prior arts on “Impact-resistance polymethacrylate moulding” compositions are well-known. Based on the proprietary method, supply of various grades of acrylic sheets are commercially available. Out of these, the primary variants have wide range of utilities. While the first one, differentiated by specialized attributes like being multi-coloured, multi-patterns, multi-sizes and multi-thicknesses leading to their high performance are made up of cell-cast process, the second sheet with a proprietary continuous process known as melt calendaring, suits almost all the uses of acrylic sheet, being endowed with the unique properties like thickness tolerance and thermoformation. On the other hand, the third variant ensures exceptional surface finish, optical quality and thickness uniformity besides, enhancing solvent craze resistance while the fourth one has an additional element of toughness (more than 50% tougher than standard acrylic sheet) instituted vide advanced impact acrylic chemistry.

It has also been found that polymers obtained by a cell cast process, which are commercially available as the first variant of the acrylic sheet, exhibits a higher-molecular-weight compared to polymers used for extrusion or injection moulding. Hence amongst its primary commercial usage, that of its usage in car windows is a feasible proposition.

Polymers produced by a cast process are not capable of further being processed by extrusion or injection moulding. Instead forming methods are used for casted sheets either through machining or thermoforming.

The inventive polymers may be obtained by cast polymerization of monomer mixtures comprising at least 50% by weight, preferably 60 to 100%, particular preferred 70 to 99% by weight, especially preferred 75 to 97% by weight and very much preferred 80 to 95% by weight, based on the weight of the matrix cast solution respectively matrix syrup, of methylmethacrylate. The monomer mixture may further comprise other (meth)acrylates or (alkyl) (meth)acrylates copolymerizable with methylmethacrylate. Such monomers are known in the art.

For example, other patents have proposed similar solutions, which are herein incorporated by reference for their supportive teachings, and includes the following:

U.S. Pat. No. 7,101,611 by Bravet, plastic window especially for motor vehicles and process for its manufacture.

Therefore there is a need for other materials that may be of use in the vehicle windshield art that are flexible and protective.

### SUMMARY OF THE INVENTION

An object of the present invention is to look into possibilities of developing new windows for cars and or utility vehicles with significant impact resistance flexible polymers, compared to glass windows, whose characteristics are mentioned above.

Another object of the present invention is to provide flexible plexiglass, or flexible acrylic sheets for cars and utility vehicles that are less harmful than tempered glass, at times of crash.

Further object of the invention is that of a coated plastic moulding comprising an impact-modified flexible polymer with very high molecular mass, which is coated with at least one abrasion resistance and/or weathering resistance coating that may be used as window in passenger cars or utility vehicles.

An object of the present invention is to produce the mentioned flexible acrylic sheet using appropriate process that remains clear and transparent over years.

Another object if the invention is to develop a flexible acrylic sheet with specification, that is in conformity with regard to impact tests and noise vibration of the automotive industry.

Another object of the present invention is to develop flexible acrylic sheets that are made from a polymethylacrylate based polymer having a molecular mass of 2,500,000 g/mol to 6,000,000 g/mol and comprising an impact modifier, wherein the plastic moulding is coated with at least one abrasion resistance and/or weathering resistance coating.

Further object of the invention not explicitly mentioned can easily be derived from the over all context of the present invention.

### SUMMARY OF THE INVENTION

Accordingly, the present invention provides an impact resistant flexible clear sheet for vehicles windshields. There is a material made of a cast polymerization of monomer mixtures comprising at least 50% by weight, based on a weight of a matrix syrup, of methylmethacrylate; wherein the monomer mixture comprise other (meth)acrylates or (alkyl) (meth)acrylates copolymerizable with methylmethacrylate; and wherein the monomer mixture comprise 0 to 10% by weight, based on a weight of a cast solution respectively syrup, of unsaturated carboxylic acids.

In another embodiment, may be that the impact resistant flexible clear sheets are plastic glass.

Wherein, another embodiment may be that the impact resistant flexible clear sheets are acrylic.

### BRIEF DESCRIPTION OF THE ACCOMPANYING DRAWINGS

The present invention will be described in more detail hereinafter with the aid of the description which relates to preferred embodiments of the invention explained with reference to the accompanying schematic drawing, in which:

FIG. 1 depicts stacks of acrylic sheets of varying sizes of the present invention.

### DETAILED DESCRIPTION OF THE PREFERRED EMBODIMENT

The foregoing objects of the present invention are accomplished and the problems and shortcomings associated with the prior art, techniques and approaches are overcome by the present invention as described below in the preferred embodiments.

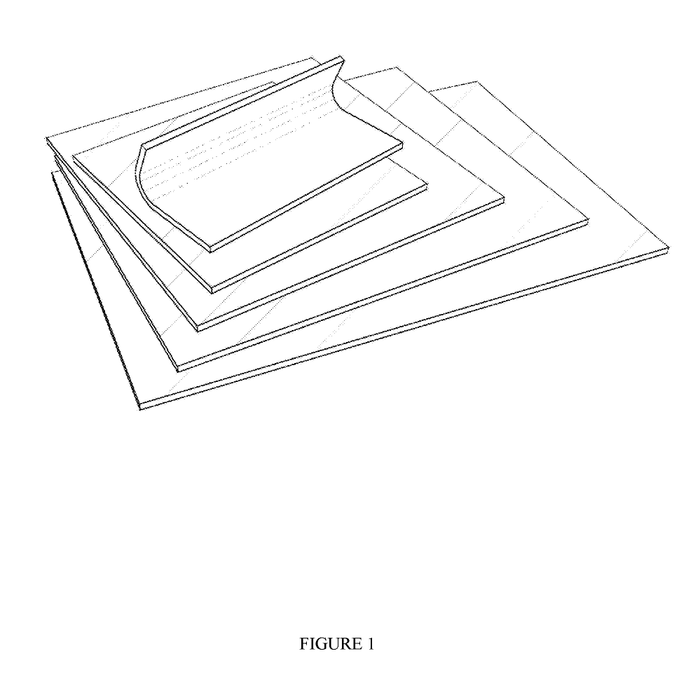

Accordingly, in one embodiment the present invention provides flexible plexiglass or acrylic sheet (FIG. 1) based on proprietary methods involving a cell cast process, which exhibits a higher-molecular-weight compared to polymers used for extrusion or injection moulding. Hence amongst its primary commercial usage, that of its usage in car windows is a feasible proposition.

In another embodiment of the present invention, wherein FIG. 1 of the present invention comprises of flexible polymers produced by a cast process, which are not capable of further processing either by extrusion or injection moulding. Instead, forming methods are used for casted sheets either through machining or thermoforming.

In the next embodiment of the present invention, the flexible polymer may be obtained by cast polymerization of monomer mixtures comprising at least 50% by weight, preferably 60 to 100%, particular preferred 70 to 99% by weight, especially preferred 75 to 97% by weight and very much preferred 80 to 95% by weight, based on the weight of the matrix cast solution respectively matrix syrup, of methylmethacrylate. The monomer mixture may further comprise other (meth)acrylates or (alkyl) (meth)acrylates copolymerizable with methylmethacrylate. The monomer mixture may further comprise 0 to 10% by weight, preferably 0 to 5% by weight and particular preferred 0 to 3% by weight, based on the weight of the cast solution respectively syrup, of unsaturated carboxylic acids.

In another embodiment of the present invention, the monomer mixture may further comprise stabilizers and other conventional additives like for example initiators, release agents and regulators. Such auxiliaries are known to those skilled in the art.

Another embodiment of the present invention is the molecular mass of the flexible polymer used in the acrylic sheet with especially preferred rate of 2,500,000 g/mol to 6,000,000 g/mol considered to be the best options.

Another embodiment of the present invention is the improvement embodied in the chemical and physical impacts of the flexible acrylic sheets vide coatings improving abrasion resistance and/or weathering resistance applied to the outer surface of the inventive mouldings. Such abrasion resistance coatings are important as it allows cleaning and ice scraping without damaging the surface of the window. The coating applied to the inventive moulding may combine different properties like scratch resistance, abrasion resistance, weathering resistance, UV protection etc.

Another embodiment of the present invention is the usage of the polymer in transparent windows of cars or utility vehicles whose weight saving is up to 50% compared to conventional tempered glass windows.

### Advantages of the Present Invention

The main advantages of the present invention are the impact resistance of the acrylic sheet being much more than tempered glass on account of its high molecular mass. Moreover, coating over the acrylic sheet to improve its physical and chemical impact as reflected in it being abrasion resistant and/or weathering resistant also scores over competing materials. Also, the exclusive feature of the sheet remaining clear for a long-time institutes an edge in its probable usage in the windows of car or other utility vehicles.

The above description is considered for that of the preferred embodiments only. It should be understood that various changes and modifications to the preferred embodiments described herein will be apparent to those skilled in the art. Therefore, it is understood that the embodiments shown in the drawings and described above are merely for illustrative purposes and are not intended to limit the scope of the invention which are defined by the following claims.

What is claimed is:

1. An impact resistant flexible clear sheet for vehicles windshields, comprising:
a) a cast polymerization of monomer mixtures comprising at least 50% by weight, based on a weight of a matrix syrup, of methylmethacrylate,
b) wherein the monomer mixture comprise other (meth)acrylates or (alkyl) (meth)acrylates copolymerizable with methylmethacrylate; and
c) wherein the monomer mixture comprise 0 to 10% by weight, based on a weight of a cast solution respectively syrup, of unsaturated carboxylic acids.

2. The impact resistant flexible sheets for vehicles windshields of claim 1, wherein the impact resistant flexible clear sheets are acrylic.

3. The impact resistant flexible sheets for vehicles windshields of claim 1, wherein the impact resistant flexible clear sheets are plastic glass.

4. The impact resistant flexible sheets for vehicles windshields of claim 3, wherein the acrylic sheets are cast by forming methods through thermoforming.

5. The impact resistant flexible sheets for vehicles windshields of claim 1, wherein the polymer has a molecular mass between 2,500,000 g/mol to 6,000,000 g/mol.

6. The impact resistant flexible sheets for vehicles windshields of claim 1, wherein the polymer comprises of an impact modifier.

7. The impact resistant flexible sheets for vehicles windshields of claim 1, wherein the sheet is coated to entail in it the properties of abrasion resistance and weathering resistance thereby maintaining its clearness and transparency.
